(19) United States
(12) Patent Application Publication
(10) Pub. No.: US 2013/0258555 A1
(43) Pub. Date: Oct. 3, 2013

(54) CAPACITOR UNIT AND STACKED SOLID ELECTROLYTIC CAPACITOR HAVING THE SAME

(71) Applicants: CHI-HAO CHIU, HSINCHU CITY (TW); CHING-FENG LIN, HSINCHU COUNTY (TW); KUN-HUANG CHANG, HSINCHU CITY (TW); CHIEN-WEI LIN, MIAOLI COUNTY (TW)

(72) Inventors: CHI-HAO CHIU, HSINCHU CITY (TW); CHING-FENG LIN, HSINCHU COUNTY (TW); KUN-HUANG CHANG, HSINCHU CITY (TW); CHIEN-WEI LIN, MIAOLI COUNTY (TW)

(73) Assignee: APAQ TECHNOLOGY CO., LTD., MIAOLI COUNTY (TW)

(21) Appl. No.: 13/437,052

(22) Filed: Apr. 2, 2012

(51) Int. Cl. H01G 9/15; H01G 5/38; H01G 9/042

(52) U.S. Cl. 361/528; 361/532; 361/541

(57) ABSTRACT

The present invention relates to a capacitor unit, which includes an anode portion, a cathode portion, and an insulating portion. The insulating portion is provided for in a form of a headband to partially cover the surface of the anode portion to divide the anode and the cathode portions. The cathode portion partially covers the anode portion and is located behind the insulating portion. The cathode portion has at least one conductive layer which is made of a conductive polymer having copper, copper alloy, or a mixture thereof.

### BACKGROUND OF THE INVENTION

1. Field of the Invention

The present invention relates to a capacitor unit and a solid electrolytic capacitor having the same. In particular, the present invention relates to a capacitor unit and a stacked solid electrolytic capacitor having the same.

2. Description of Related Art

Capacitors are widely used in modern electronic products, such as PCs, power supply units, communication devices, or vehicles for storing electrical charge, filtering signals, bypassing or tune-oscillating signals.

Capacitors play a very important role in modern electronic products. Capacitors are roughly divided into two kinds according to the kind of the electrolyte layer; a liquid electrolytic capacitor and a solid electrolytic capacitor. The liquid electrolytic capacitor ends its life when the electrolyte is exhausted. Typically, the liquid electrolytic capacitor has a service life of about 1000 hours while operating at 105 degrees Celsius, and the life of the liquid electrolytic capacitor is doubled when the operation temperature is decreased by 10 degrees Celsius. Regarding the solid electrolytic capacitor, it has a longer service life, because the properties of the solid-state electrolyte. On the other hand, conductive polymers are commonly used in the solid electrolytic capacitor because of the high conductivity and high temperature stability of the conductive polymers.

Some solid electrolytic capacitor units are stacked structurally to form a stacked solid electrolytic capacitor. The outer surface of the cathode electrode is formed by a silver paste, and the silver paste is used again to connect the adjacent solid electrolytic capacitor units to each other. However, the silver material has a high cost and it is necessary to find a replacement material to reduce the manufacturing cost of the stacked solid electrolytic capacitor.

### SUMMARY OF THE INVENTION

One object of the instant disclosure is providing a glue/paste or an adhesive containing copper (Cu), Cu alloy, or a mixture thereof to manufacture stacked solid-state electrolytic capacitor. Due to the material properties of Cu, the manufacturing processes are optimized and the manufacturing cost is reduced. On the other hand, the properties of the manufactured capacitor devices can be improved.

The instant disclosure provides a capacitor unit including: an anode portion, a cathode portion, and an insulating portion. The insulating portion is provided for in a form of a headband to partially cover the surface of the anode portion. The cathode portion partially covers on the anode portion and is located behind the insulating portion, and the cathode portion at has at least one conductive layer which is made of a conductive polymer having copper, copper alloy or a mixture of said copper and copper alloy.

The instant disclosure provides a stacked solid-state electrolytic capacitor comprising: a plurality of capacitor units, a positive lead frame, a negative lead frame, and a package unit. The capacitor units are stacked onto each other and each capacitor unit has an anode portion, a cathode portion and an insulating portion. The insulating portion is provided for in a form of a headband to partially cover the surface of the anode portion. The cathode portion partially covers on the anode portion and is located behind the insulating portion, and the cathode portion has at least one conductive layer. The adjacent capacitor units have an adhesive layer therebetween. At least one of the conductive layer and the adhesive layer is made of a conductive polymer having copper, copper alloy or a mixture of said copper and copper alloy. The positive lead frame is electrically connected to the anode portion of each of the capacitor units. The negative lead frame is electrically connected to the cathode portion of each of the capacitor units. The package unit covers the capacitor units and partially covers the positive and the negative lead frames.

The instant disclosure provides Cu glue to replace the traditional Ag glue. Due to the material price, the usage of the Cu glue can be provided for reduce the manufacturing cost. Furthermore, because copper is more suitable for low-temperature manufacturing process, the device can be protected from subjecting to high temperature process; therefore, the manufactured capacitors have improved reliability.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 shows a capacitor unit of the first embodiment of the instant disclosure.

FIG. 2A shows the capacitor units of the first embodiment stacked in a single-side manner of the instant disclosure.

FIG. 2B shows the capacitor units of the first embodiment stacked in a double-side manner of the instant disclosure.

FIG. 3 shows a stacked solid electrolytic capacitor having the capacitor units of the first embodiment of the instant disclosure.

FIG. 4 shows a capacitor unit of the second embodiment of the instant disclosure.

FIG. 5 shows the capacitor units of the second embodiment stacked in a single-side manner of the instant disclosure.

FIG. 6 shows a stacked solid electrolytic capacitor having the capacitor units of the second embodiment of the instant disclosure.

FIG. 7 shows a capacitor unit of the third embodiment of the instant disclosure.

### DETAILED DESCRIPTION OF THE PREFERRED EMBODIMENTS

The instant disclosure provides a capacitor unit and a stacked solid-state electrolytic capacitor having the same. The capacitor unit is manufactured by using glue containing copper or adhesive containing copper to decrease the manufacturing cost of the capacitor unit and the stacked solid-state electrolytic capacitor. Furthermore, due to the properties of copper material, the manufacturing temperature of the capacitor unit and the stacked solid-state electrolytic capacitor may be reduced so that the reliability of the capacitor can be improved.

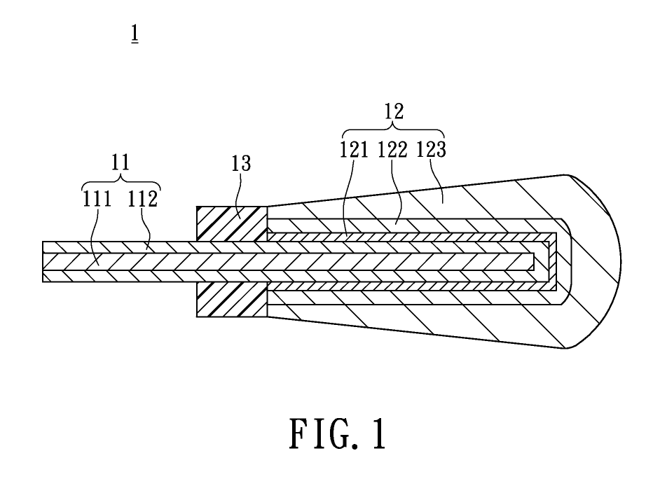

Please refer to FIG. 1; a first exemplary embodiment is shown and a capacitor unit 1 includes an anode portion 11, a cathode portion 12, and an insulating portion 13. The cathode portion 12 has a multi-layer structure, where one of the layers of the cathode portion 12 is a conductive layer 123. The conductive layer 123 is made of a conductive polymer having copper, copper alloy or a mixture of said copper and copper alloy (i.e., a Cu glue or Cu adhesive).

The anode portion 11 has a valve metal foil 111 (e.g., an aluminum foil) and an oxide dielectric layer 112 (e.g., an aluminum oxide layer) coated on and to cover the valve metal foil 111. The oxide dielectric layer 112 is used to electrically isolate the anode portion 11 and the cathode portion 12.

The cathode portion 12 and the insulating portion 13 are partially covering the anode portion 11 and one end of the anode portion 11 exposes from the cathode portion 12 and the insulating portion 13. The cathode portion 12 has an inner conductive polymer layer 121, a middle carbon glue layer 122 and the outer conductive layer 123. In the exemplary embodiment, the cathode portion 12 is U-shaped to clamp the anode portion 11 therebetween. The insulating portion 13 is formed in front of the U-shaped cathode portion 12 to establish a form of a headband and to partially cover the surface of the anode portion 11. In structural detail, the cathode portion 12 is located behind the insulating portion 13, and the conductive polymer layer 121 of the cathode portion 12 partially covers the surface of the oxide dielectric layer 112 of the anode portion 11. Moreover, the carbon glue layer 122 covers the surface of the conductive polymer layer 121, and the conductive layer 123 covers the surface of the carbon glue layer 122. The conductive polymer layer 121 may be a film of polythiophene derivatives, such as a poly(3,4-ethylenedioxythiophene) (PEDOT) film. As mentioned, the conductive layer 123 may be made of a conductive polymer having copper, copper alloy or a mixture of copper and copper alloy (i.e., a Cu glue or Cu adhesive); wherein the copper, copper alloy or the mixture of the conductive polymer has a solid content ranging from about 40% to 90%, preferably ranging from about 50% to 70%.

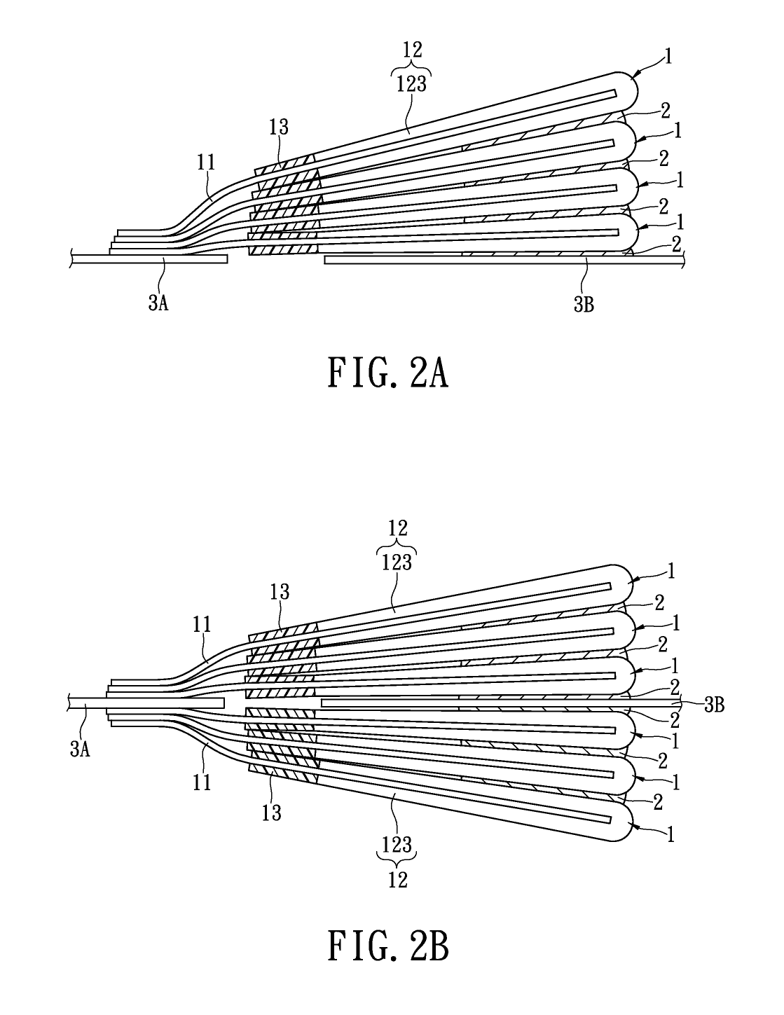

Please refer to FIGS. 2A and 2B; the capacitor set which is formed by stacking multi capacitor units 1 of the first embodiment is shown. The quantity of the stacked capacitor units 1 is not limited thereby, for example, the capacitor set may be formed by stacking two to twenty capacitor units 1. Preferably, the capacitor set may be formed by stacking two to twelve capacitor units 1. The single-side stacked type and the double-side stacked type are respectively shown in FIGS. 2A and 2B.

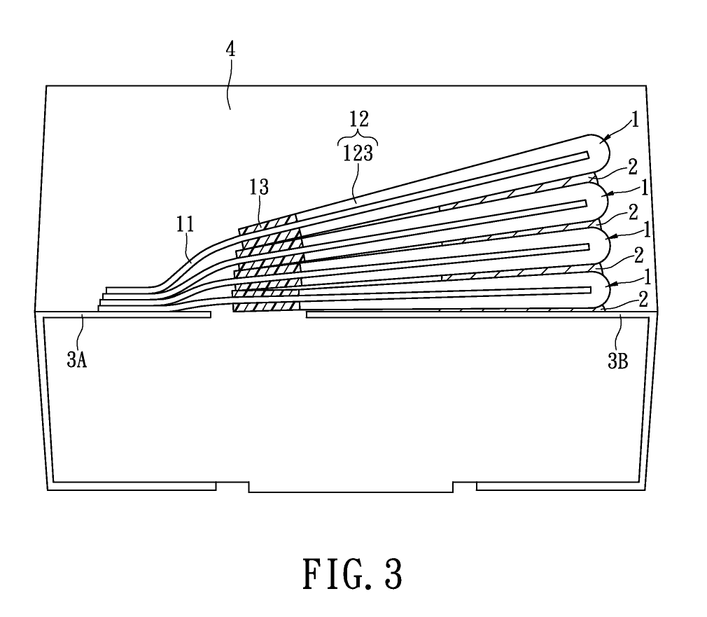

Please refer to FIG. 3; a stacked solid-state electrolytic capacitor by using the single-side stacked capacitor units 1 is shown. The stacked solid-state electrolytic capacitor includes a plurality of stacked capacitor units 1, a positive lead frame 3A, a negative lead frame 3B, and a package unit 4. As illustrated, the capacitor units 1 are stacked layer-by-layer, and the cathode portions 12 of the adjacent capacitor units 1 are electrically connected by an adhesive layer 2. Similarly, the cathode portion 12 of the inner capacitor unit 1 is electrically connected to the negative lead frame 3B by the adhesive layer 2. The front end of the anode portion 11 of each capacitor unit 1 is bent and welded onto the positive lead frame 3A so that the anode portions 11 of the capacitor units 1 are electrically connected with the positive lead frame 3A. In addition, the package unit 4 may be formed by insulated, heat-resist resins to cover and package the stacked capacitor units 1 and partially cover the positive and the negative lead frames 3A, 3B. In other words, the exposed portions of the positive and negative lead frames 3A, 3B from the package unit 4 can be connected to external device or circuitry.

Similar with the conductive layer 123, the adhesive layer 2 disposed between the cathode portions 12 are made of a conductive polymer having copper, copper alloy or a mixture of copper and copper alloy (i.e., a Cu glue or Cu adhesive). Alternatively, the adhesive layer 2 and the conductive layer 123 may be silver (Ag) glue or another adhesive material. In other words, at least one of the conductive layer 123 and the adhesive layer 2 is made of a conductive polymer having copper, copper alloy or a mixture of said copper and copper alloy. For example, the conductive layer 123 is formed by Cu glue and the adhesive layer 2 is formed by Ag glue. In an alternative embodiment, the conductive layer 123 is formed by Ag glue and the adhesive layer 2 is formed by Cu glue. In a still alternative embodiment, the conductive layer 123 is formed by Cu glue and the adhesive layer 2 is formed by Cu glue.

Please refer to FIG. 3; the manufacturing method of the stacked solid-state electrolytic capacitor having Cu-contained conductive layer 123 and Cu-contained adhesive layer 2 is described hereinafter.

Step 1 is providing at least one capacitor set. As shown in FIG. 3, the capacitor set of the embodiment has four capacitor units 1. Each capacitor unit 1 includes an anode portion 11, a cathode portion 12, and an insulating portion 13. The front end of the anode portion 11 of each capacitor unit 1 is bent to form as a positive electrode. The insulating portion 13 surrounds the anode portion 11 and covers the anode portion 11 partially. The cathode portion 12 is bent to have a U-shaped structure and covers the anode portion 11 partially. The cathode portion 12 is located behind the insulating portion 13 and the insulating portion 13 is used to electrically isolate the anode portion 11 and the cathode portion 12. The conductive layer 123 is made of Cu glue. On the other hand, the four capacitor units 1 are stacked layer-by-layer and the cathode portions 12 of the adjacent capacitor units 1 have the adhesive layer 2 of Cu glue therebetween so that the cathode portions 12 of the capacitor units 1 are electrically connected with each other.

Step 2 is connecting and assembling the capacitor set onto the positive and the negative lead frames 3A, 3B. The anode portions 11 of the stacked capacitor units 1 are welded and fixed to the positive lead frame 3A, such as by laser welding, resistance welding, or ultrasonic welding method. By coating Cu glue on the negative lead frame 3B, the adhesive layer 2 is established so as to connect and fix the cathode portion 12 on the negative lead frame 3B.

Step 3 is forming the package unit 4 to cover the stacked capacitor units 1 and partially cover the positive and the negative lead frames 3A, 3B.

In the above-mentioned steps, the manufacturing temperature may be decreased due to the material properties of Cu. Therefore, the reliability of the manufactured capacitor is improved due to the lower manufacturing temperature. Moreover, the usage of Cu glue is provided for the decrease of the material cost.

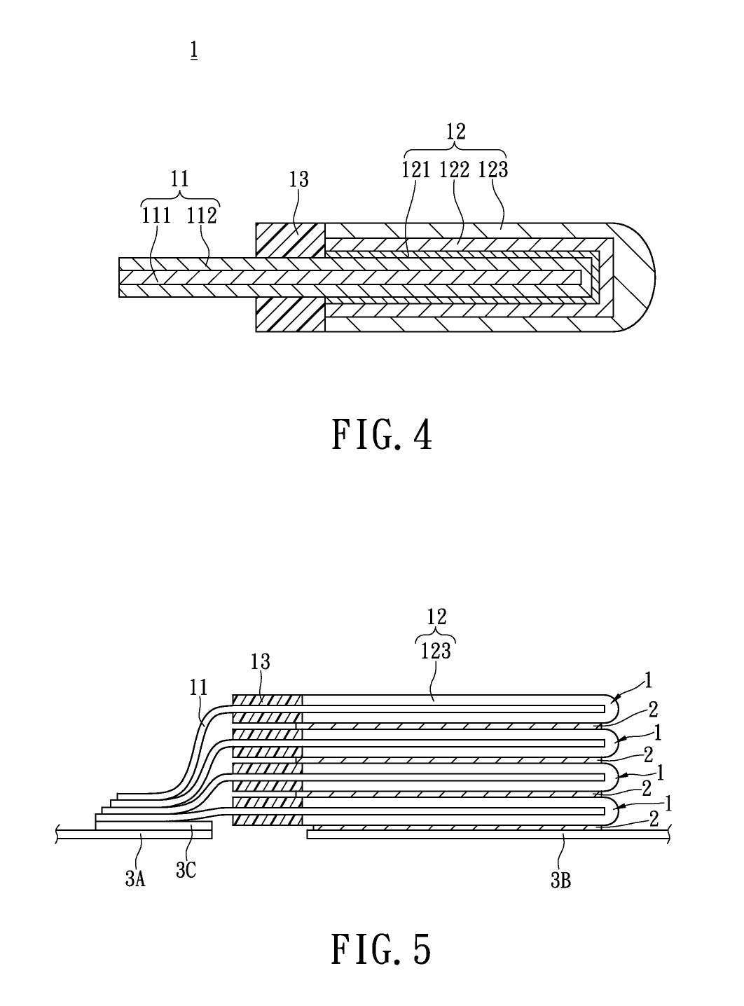

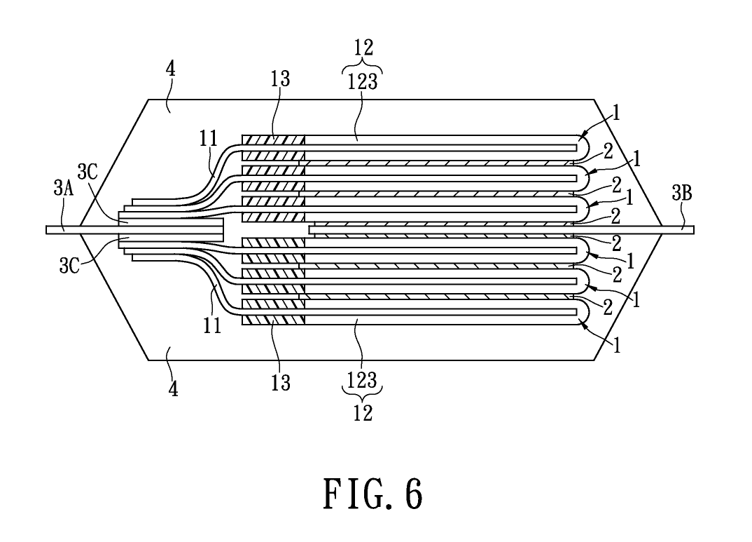

Please refer to FIG. 4; the capacitor unit 1 of the second exemplary embodiment is shown. In this embodiment, the conductive layer 123 has uniform thickness. Regarding the first exemplary embodiment, the conductive layer 123 has an increasing thickness in a direction away from the insulating portion 13. In other words, for the previous embodiment, the thickness of the bending segment of the cathode portions 12 is larger than the thickness of the free-end segment of the cathode portions 12. However, the thickness of the bending segment of the cathode portions 12 is substantially equal to the thickness of the free-end segment of the cathode portions 12 for the second embodiment. FIG. 5 shows that a capacitor set by stacking four capacitor units 1 of the second exemplary embodiment. As illustrated, the capacitor units 1 are substantially arranged parallel to each other. That means that the capacitor units 1 are parallel to the positive and the negative lead frames 3A, 3B. FIG. 6 shows that a stacked solid-state electrolytic capacitor by stacking the capacitor units 1 of the second exemplary embodiment in a double-side manner. Similarly, at least one of the conductive layer 123 and the adhesive layer 2 is made of a conductive polymer having copper, copper alloy or a mixture of said copper and copper alloy so as to decrease the manufacturing cost and improve the device reliability.

On the other hand, the stacked solid-state electrolytic capacitor, as shown in FIGS. 5 and 6, can further has an auxiliary lead frame 3C which is fixed onto the positive and/or the negative lead frames 3A, 3B by welding or by attaching methods, such as the conductive layer 123. In the embodiment, the auxiliary lead frame 3C is welded onto the positive lead frame 3A and the bent positive electrode of the anode portions 11 is fixedly mounted onto the auxiliary lead frame 3C. The auxiliary lead frame 3C is provided for increasing the thickness of the positive lead frame 3A to reduce the bending degree of the anode portions 11; therefore, the current leakage may be reduced.

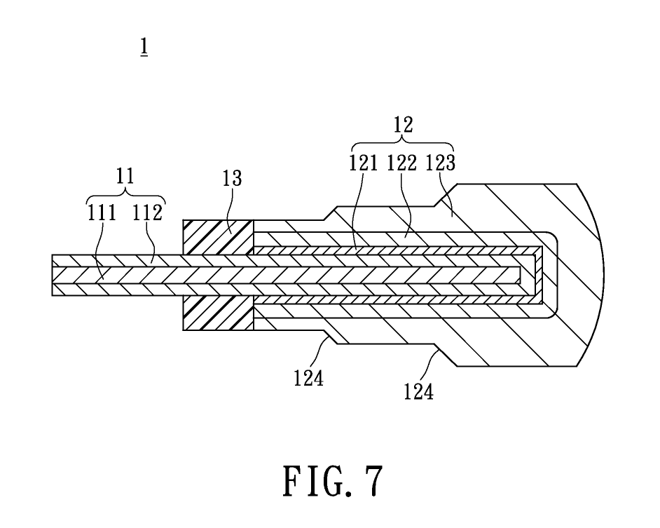

Please refer to FIG. 7; the capacitor unit 1 of the third exemplary embodiment is shown. In this embodiment, the conductive layer 123 of the cathode portion 12 has a step-shaped structure 124, and the quantity of the step-shaped structure 124 is not restricted thereby. Similar with the first exemplary embodiment, the step-shaped structure 124 is provided for varied thickness of the cathode portion 12; as shown, the thickness of the bending segment of the cathode portions 12 is larger than the thickness of the free-end segment of the cathode portions 12. Due to the varying thickness of the cathode portion 12, the bending degree of the anode portions 11 may be reduced; therefore, the current leakage may be reduced.

According to experiments, the properties, such as ESR (Equivalent Series Resistance) of the Cu-contained and the Ag-contained stacked solid-state electrolytic capacitors are shown below:

| | | | |
|---|---|---|---|
| Cu glue | Ag glue | Ag glue | Ag glue |

Layers of unit

| | | | |
|---|---|---|---|
| 3 | 3 | 3 | 3 |

Required ESR
9 mΩ

| NO. | ESR | ESR | ESR | ESR |
|---|---|---|---|---|
| No, 1 | 6.5 | 6.2 | 6.2 | 6.8 |
| No, 2 | 5.2 | 6 | 6.7 | 7 |
| No, 3 | 5.8 | 6.8 | 7.2 | 8.5 |
| No, 4 | 5.5 | 7 | 7.2 | 7.5 |
| No, 5 | 7.4 | 7.1 | 6.8 | 7.4 |
| No, 6 | 5.8 | 7.7 | 7.1 | 6.5 |
| No, 7 | 5.7 | 7.2 | 8.9 | 9 |
| No, 8 | 6.2 | 7.6 | 6.7 | 7.3 |
| No, 9 | 5.6 | 7.1 | 5.8 | 6.2 |
| No, 10 | 5.9 | 7.1 | 6.3 | 6.8 |
| No, 11 | 6.7 | 6.2 | 7.2 | 7.1 |
| No, 12 | 6.7 | 6.2 | 6.5 | 7 |
| No, 13 | 6 | 6.8 | 5.7 | 6.3 |
| No, 14 | 6.8 | 6.9 | 6.8 | 7.3 |
| No, 15 | 5.9 | 6.7 | 6.9 | 7.4 |
| No, 16 | 5.7 | 8.5 | 8.7 | 8.6 |
| No, 17 | 5.2 | 6 | 7 | 5.9 |
| No, 18 | 4.9 | 7.5 | 8.5 | 8.5 |
| No, 19 | 5.3 | 7.5 | 6.4 | 8.1 |
| No, 20 | 4.9 | 6.9 | 8.8 | 7.5 |
| No, 21 | 5.6 | 7 | 5.5 | 7.5 |
| No, 22 | 5.3 | 8.7 | 6 | 6.4 |
| No, 23 | 5.4 | 7.2 | 5.1 | 7.7 |
| No, 24 | 5.6 | 7.2 | 6.1 | 5.9 |

Depending on the ESR testing results, the ESR data of the capacitor manufactured by the Cu glue can meet the requirements of less than 9 mΩ. Moreover, the ESR data of the capacitor manufactured by the Cu glue indicates better performance over the capacitor manufactured by the Ag glue.

The advantages of the instant disclosure are following:

1. The usage of the Cu glue may decrease the manufacturing temperature, for example, the temperature is lowered from approximately 130-170 degrees Celsius to 100-130 degrees Celsius so as to reduce the energy consumed and manufacturing cost. Furthermore, the device is kept from the higher processing temperature and the reliability can be improved.

2. The properties of the capacitor manufactured by the Cu glue can meet the requirements, such as the current leakage or ESR.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A capacitor unit, comprising:
an anode portion;
a cathode portion; and
an insulating portion, wherein the insulating portion is provided for in a form of a headband to partially cover the surface of the anode portion, while the cathode portion partially covers on the anode portion and is located behind the insulating portion, with the cathode portion having at least one conductive layer which is made of a conductive polymer having copper, copper alloy, or a mixture of the copper and copper alloy.

2. The capacitor unit as claimed in claim 1, wherein the copper, the copper alloy, or the mixture thereof of the conductive polymer has a solid content ranged from 40% to 90%.

3. The capacitor unit as claimed in claim 1, wherein the copper, the copper alloy, or the mixture thereof of the conductive polymer has a solid content ranged from 50% to 70%.

4. The capacitor unit as claimed in claim 3, wherein the anode portion has a valve metal foil and an oxide dielectric layer covering the valve metal foil.

5. The capacitor unit as claimed in claim 2, wherein the anode portion has a valve metal foil and an oxide dielectric layer covering the valve metal foil.

6. The capacitor unit as claimed in claim 5, wherein the cathode portion further has a conductive polymer layer partially covering the surface of the oxide dielectric layer and a carbon glue layer covering the conductive polymer layer, with the conductive layer covering the carbon glue layer.

7. The capacitor unit as claimed in claim 6, wherein the cathode portion is U-shaped, and wherein the cathode portion has a bending segment and a free-end segment, with the thickness of the bending segment being greater than the thickness of the free-end segment.

8. The capacitor unit as claimed in claim 1, wherein the outer surface of the conductive layer has at least one step-shaped structure.

9. A stacked solid-state electrolytic capacitor, comprising:
a plurality of capacitor units stacked onto each other, wherein each capacitor unit has an anode portion, a cathode portion, and an insulating portion, wherein the insulating portion is provided for in a form of a headband to partially cover the surface of the anode portion, while the cathode portion partially covers the anode portion and is located behind the insulating portion, wherein the cathode portion at has at least one conductive layer, wherein the adjacent capacitor units have an adhesive layer therebetween, wherein at least one of the conductive layer and the adhesive layer is made of a conductive polymer having copper, copper alloy, or a mixture of the copper and copper alloy;
a positive lead frame electrically connected to the anode portion of each of the capacitor units;
a negative lead frame electrically connected to the cathode portion of each of the capacitor units; and
a package unit covering the capacitor units and partially covering the positive and the negative lead frames.

10. The stacked solid-state electrolytic capacitor as claimed in claim 9, wherein the copper, the copper alloy, or the mixture thereof for the conductive polymer has a solid content ranged from 40% to 90%.

11. The stacked solid-state electrolytic capacitor as claimed in claim 9, wherein the copper, the copper alloy, or the mixture thereof of the conductive polymer has a solid content ranged from 50% to 70%.

12. The stacked solid-state electrolytic capacitor as claimed in claim 11, wherein the anode portion has a valve metal foil and an oxide dielectric layer covering the valve metal foil.

13. The stacked solid-state electrolytic capacitor as claimed in claim 10, wherein the anode portion has a valve metal foil and an oxide dielectric layer covering the valve metal foil.

14. The stacked solid-state electrolytic capacitor as claimed in claim 13, wherein the cathode portion further has a conductive polymer layer partially covering the surface of the oxide dielectric layer and a carbon glue layer covering the conductive polymer layer, and wherein the conductive layer covers the carbon glue layer.

15. The stacked solid-state electrolytic capacitor as claimed in claim 14, wherein the cathode portion is U-shaped, and wherein the cathode portion has a bending segment and a free-end segment, with the thickness of the bending segment being greater than the thickness of the free-end segment.

16. The stacked solid-state electrolytic capacitor as claimed in claim 14, wherein the adhesive layer is further formed between the capacitor units and the negative lead frame.

17. The stacked solid-state electrolytic capacitor as claimed in claim 9, wherein the outer surface of the conductive layer has at least one step-shaped structure.

18. The stacked solid-state electrolytic capacitor as claimed in claim 9, further comprising an auxiliary lead frame disposed on the positive lead frame.
